(19) United States
(12) Patent Application Publication
(10) Pub. No.: US 2005/0003873 A1
(43) Pub. Date: Jan. 6, 2005

(54) Directional indicator for antennas

(75) Inventors: Arun Naidu, Woodinville, WA (US); Alex Vdolek, Redmond, WA (US); Samuel McKernan, Redmond, WA (US)

Correspondence Address: BINGHAM, MCCUTCHEN LLP, THREE EMBARCADERO, SUITE 1800, SAN FRANCISCO, CA, 94111-4067, US

(73) Assignee: Netro Corporation

(21) Appl. No.: 10/612,758

(22) Filed: Jul. 1, 2003

(51) Int. Cl. H04B 1/38; H04B 1/10

(52) U.S. Cl. 455/575.7; 455/63.4; 455/562.1

(57) ABSTRACT

A system for receiving a communication signal includes an antenna that can be coupled to a subscriber terminal, a compass secured to the antenna, the compass adapted to measure an orientation of the antenna, a memory unit for storing data associated with a desired mounting configuration of the antenna, and a processor, the processor configured to generate a signal based on the measured orientation and the data stored in the memory unit. A device for installing an antenna includes a structure attachable to the antenna, a compass secured to the structure, the compass adapted to measure an orientation of the antenna, a memory unit for storing data associated with a desired mounting configuration of the antenna, and a processor, the processor configured to generate a signal based on the measured orientation and the data stored in the memory unit.

### BACKGROUND OF THE INVENTION

1. Field of the Invention

The field of the invention relates to wireless subscriber equipments, and more particularly, to systems and methods for installing antennas.

2. Background of the Invention

Known subscriber equipments employed for local telecommunication networks generally comprise a directional antenna, a transceiver, and a decoder located within or adjacent a subscriber's premise. The antenna receives a signal from a base station and the transceiver and decoder decodes the signal for various applications.

The antenna is typically secured to a pole, a chimney, an exterior wall, a balcony, or other structures within the subscriber's premise. In order to obtain signals of sufficient strength, the antenna is installed such that it faces in a desired direction. For example, if it is desirable for the antenna to receive signals transmitted directly from a certain base station, the antenna is installed such that its peak reception plane faces in the direction of the base station.

FIG. 1 shows an example of a radiation or gain pattern 2 (in a horizontal plan view) for an antenna 4. As shown in the figure, antenna 4 has highest gain at 0° (associated with a “main lobe ”in the gain pattern 2) with respect to a local axis 6 of antenna 4. However, antenna 4 can also pick up a significant amount of signal from other directions, such as at 180 ° (associated with a “back lobe ”in gain pattern 2), 40° (associated with one “side lobe ”in gain pattern 2), and 320° (associated with another “side lobe ”in gain pattern 2) relative to local axis 6 of antenna 4. When installing an antenna, it is generally desirable to orient the antenna such that its main lobe is aligned with a base station for optimal signal quality and minimal interference (FIG. 2). Often times, due to human error, antennas are installed such that their main lobes are not aligned with the desired or intended base stations. For example, an antenna may be accidentally installed to have one of its side lobes or its back lobe aligned with the desired base station (FIG. 3). In this case, while a signal of sufficient quality can still be received by the antenna, a subscriber terminal user may experience a significant level of interference. In addition, incorrectly installed antenna may also cause interference to a base station located in a direction that the antenna is facing (as represented by dotted arrows in FIG. 3).

Therefore, proper performance of the telecommunication network requires antennas to be installed correctly. When installing antennas, technicians have had difficulties in determining correct orientations of the antennas in reference to a desired base station or direction. Although a technician may use a hand-held compass to determine the orientation of an antenna being installed, the antenna can still be installed incorrectly due to human error. In addition, the technician may forget to bring a hand-held compass, or not use a compass even if one is available. Furthermore, with existing antennas and installation techniques, it may be difficult or time consuming for the technician to verify whether an antenna has been installed correctly.

Accordingly, improved systems and methods for installing antennas would be useful.

### SUMMARY OF THE INVENTION

The present invention provides system and method for receiving communication signal. In some embodiments of the invention, the system includes an antenna that can be coupled to a subscriber terminal, a compass secured to the antenna, a memory unit for storing data associated with a desired mounting configuration of the antenna, and a processor coupled to the compass and the memory unit. The compass is adapted to measure an orientation of the antenna, and the processor is configured to generate a signal based on a measured orientation of the antenna by the compass and data stored in the memory unit.

A device for installing an antenna is further provided. In some embodiments of the invention, the device includes a structure attachable to the antenna, a compass secured to the structure, a memory unit for storing data associated with a desired mounting configuration of the antenna, and a processor coupled to the compass and the memory unit. The compass is adapted to measure an orientation of the antenna, and the processor is configured to generate a signal based on a measured orientation of the antenna by the compass and data stored in the memory unit.

A device for processing data associated with an installation of an antenna is also provided. In some embodiments of the invention, the device includes a processor configured to receive an input associated with a measured orientation of an antenna, compare the input with data associated with a desired mounting configuration of the antenna, and generate a signal based on the comparison.

A method of installing an antenna is further provided. In some embodiments of the invention, the method includes securing the antenna to a structure. The antenna carries a feedback device that provides a signal based on an orientation of the antenna and a desired mounting configuration of the antenna. The method also includes adjusting a position or orientation of the antenna based on the signal, information encoded in the signal, or an absence of the signal.

A method of initializing a memory unit secured to an antenna is also provided. In some embodiments of the invention, the method includes inputting data associated with a desired mounting configuration of the antenna to the memory unit.

Other aspects and features of the invention will be evident from reading the following detailed description of the preferred embodiments, which are intended to illustrate, but not limit, the invention.

### BRIEF DESCRIPTION OF THE DRAWINGS

The drawings illustrate the design and utility of preferred embodiments of the present invention, in which similar elements are referred to by common reference numerals. In order to better appreciate how advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting its scope, the invention will be described and explained with additional specificity and detail through the use of the accompanying drawings.
FIG. 1 is an example of a gain pattern of an antenna;
FIG. 2 is a map showing examples of desired mounting configurations of antennas relative to base stations, and corresponding radiation patterns of antennas;
FIG. 3 is a map showing examples of incorrect mounting configurations of antennas;
FIG. 4 is a diagrammatic perspective view of a system, which includes a feedback unit constructed in accordance with some embodiments of the invention;
FIG. 5A is a diagrammatic view of some embodiments of the feedback unit of FIG. 4;
FIG. 5B shows functional steps performed by a processor in accordance with some embodiments of the invention;
FIG. 6 is a diagrammatic view of other embodiments of the feedback unit of FIG. 4;
FIGS. 7A and 7B illustrate a process of initializing the feedback device of FIG. 4 in accordance with some embodiments of the invention;
FIGS. 8A and 8B illustrate a process of initializing the feedback device of FIG. 4 in accordance with some embodiments of the invention; and
FIG. 9 shows a process of installing an antenna in accordance with some embodiments of the invention.

### DETAILED DESCRIPTION OF THE PREFERRED EMBODIMENTS

Various embodiments of the present invention are described hereinafter with reference to the figures. It should be noted that the figures are not drawn to scale and that elements of similar structures or functions are represented by like reference numerals throughout the figures. It should also be noted that the figures are only intended to facilitate the description of specific embodiments of the invention. They are not intended as an exhaustive description of the invention or as a limitation on the scope of the invention. In addition, an illustrated embodiment needs not have all the aspects or advantages of the invention shown. An aspect or an advantage described in conjunction with a particular embodiment of the present invention is not necessarily limited to that embodiment and can be practiced in any other embodiments of the present invention even if not so illustrated herein.

FIG. 4 illustrates a system 10 for receiving a communication signal, which includes an antenna 12 and a feedback device 14 constructed in accordance with some embodiments of the present inventions. In the illustrated embodiment, antenna 12 includes a satellite dish that is attachable to a subscriber terminal. However, antenna 12 can also be a variety of devices capable of receiving and/or transmitting radio signals. In addition, antenna 12 is not limited to the diamond shape shown in the FIG. 4, and can have other shapes, such as a circular or an elliptical shape. In the illustrated embodiment, feedback device 14 is secured externally to the back of antenna 12. Alternatively, feedback device 14 can be secured internally to antenna 12, to another location on antenna 12, or to another structure connected to antenna 12. The securing of feedback device 14 to antenna 12 can be accomplished using a screw, a weld, an adhesive, a mechanical connection, or other known securing mechanisms. The securing can be performed during a manufacturing process, or at a site by an installation technician.

In some embodiments of the invention, the system 10 also includes a support member 42, a first mounting member 44, and a second mounting member 46. First mounting member 44 is adapted to be secured to a structure 19, such as a wall, a balcony, other components of a house, or other structures at a subscriber's premise. Second mounting member 46 is configured for securing antenna 12 to support member 42. An azimuth angle of antenna 12 can be adjusted by rotating antenna 12 relative to support member 42, and an elevation angle of antenna 12 can be adjusted by rotating support member 42 about a hinge 49. Fine adjustment of the azimuth angle and the elevation angle of antenna 12 can also be performed by adjusting screws 48. It should be noted that the support and mounting devices should not be limited to the example shown in these embodiments, and that other types of mounting and support devices can also be used as long as they allow antenna 12 to be mounted to structure 19.

FIG. 5A shows a block diagram of a feedback device 14a in accordance with some embodiments of the present invention. Feedback device 14a includes a compass 54, a processor 55, a memory unit 56, and an indicator 58. Compass 54, memory unit 56, and indicator 58 are coupled to processor 55. Feedback unit 14a can also include a structure 59 that carries compass 54, processor 55, memory unit 56, and indicator 58. Structure 59 can be, for examples, a housing or a casing, or a component of antenna 12. Feedback unit 14a also includes an input port 57 for receiving data, which is processed by processor 55 before being stored in memory unit 56. Alternatively, memory unit 56 can be configured to receive data directly via the port 57. In some embodiments, feedback device 14a also includes a power source (not shown) for providing power to compass 54, processor 55, memory unit 56, and/or indicator 58. The power source can be, for examples, a battery or a solar energy source. Alternatively, feedback device 14a can include a cable or a wire that connects compass 54, processor 55, memory unit 56, and/or indicator 58 to a power source, such as an electrical outlet or to a power supply for antenna 12.

Compass 54 is configured to sense or measure an azimuth angle (i.e., an angle of antenna 12 relative to a global reference about a vertical axis, such as the Z-axis of FIG. 4) of antenna 12, which defines a direction to which antenna 12 is facing. In some embodiments of the invention, compass 54 is an electronic compass that senses magnetic fields. Compass 54 includes one or more sensors that respond (e.g., change inductance) to different magnetic field strengths, and outputs a signal representative of a strength of a sensed magnetic field. Examples of electronic compass that can be used include those manufactured by PNI Corporation, Santa Rosa, Calif. Other types of compass or devices can also be used as long as they are capable of sensing or measuring directions to which antenna 12 is facing.

Processor 55 is electrically connected to compass 54 and memory unit 56. Processor 55 is configured to receive input data from port 57, process the input data, and store the input data into memory unit 56 during an initialization process of feedback unit 14. The initialization process will be described below. Memory unit 56 includes a non-volatile memory for storing data associated with a desired mounting configuration of antenna 12. Memory unit 56 can be any of a variety of memory devices, such as a serial EEPROM memory, manufactured by Atmel Corporation, at San Jose, Calif., or a flash memory, manufactured by Advanced Micro Devices, Inc., at Sunnyvale, Calif. Examples of data that can be stored in memory unit 56 includes a desired height of installation, a desired azimuth angle of antenna 12, a desired elevation angle (e.g., angle about a horizontal axis, such as the X-axis of FIG. 4) of antenna 12, base station location, base station identification, subscriber location, and subscriber identification. Data stored in memory unit 56 is accessible by processor 55.

During use, processor 55 generates a signal based on a measured orientation of antenna 12 and data stored in memory unit 56. Particularly, as shown in FIG. 5B, processor 55 is configured to receive an input associated with a measured orientation of antenna 12 from compass 54 (step 50), read a stored data associated with a desired mounting configuration of antenna 12 from memory unit 56 (step 51), compare the input with stored data (step 52), and generate a signal based on such comparing (step 53). In the illustrated embodiments, processor 55 generates a signal when a measured azimuth angle of antenna 12 is substantially the same or within a prescribed threshold from a desired azimuth angle stored in memory unit 56. Alternatively, processor 55 generates a signal when a measured azimuth angle of antenna 12 is not substantially the same or beyond a prescribed threshold from a desired azimuth angle stored in memory unit 56. Processor 55 can be a microprocessor or other types of circuit configured for performing the functions described herein. Examples of processor 55 that can be used include processors manufactured by Motorola, Inc., at Schaumburg, Ill.

Indicator 58 provides feedback to the user or installer by generating a response based on the signal received from processor 55. In some embodiments, indicator 58 includes a light source, such as a bulb, a light emitting diode (LED), or other display mechanism, that emits a light signal when the measured direction by compass 54 is equal to, or within a prescribed threshold from, the stored direction in memory unit 56. The prescribed threshold may be between the ±3 dB points of the main lobe, for example, ±22°. Other ranges of threshold may also be used. Alternatively, the light source of indicator 58 can emit a light signal when the measured direction by compass 54 is not equal to, or beyond a prescribed threshold from, the stored direction in memory unit 56. In some embodiments of the invention, the light source may emit lights having different wavelengths in response to a degree of difference between the measured and stored directions.

In other embodiments, indicator 58 includes an audio source that emits a sound when the measured direction by compass 54 is equal to, or within a prescribed threshold from, the stored direction in memory unit 56. Alternatively, the audio source of indicator 58 can emit a sound when the measured direction by compass 54 is not equal to, or beyond a prescribed threshold from, the direction stored in memory unit 56. In some embodiments of the invention, the audio source may emit sounds having different pitches, loudness, or tempos in response to a degree of difference between the measured and stored directions.

In other embodiments of the invention, indicator 58 includes a screen for displaying data or graphic in response to a direction measured by compass 54. For example, the screen can display a graphic when the measured direction by compass 54 is equal to, or within a prescribed threshold from, the direction stored in memory unit 56. Alternatively, the screen of indicator 58 can display a graphic when the measured direction by compass 54 is not equal to, or beyond a prescribed threshold from, the stored direction in memory unit 56. The screen may also display data representative of a measured direction by compass 54, the stored direction in memory unit 56, and/or a difference between the measured and stored directions. Other information associated with installation of antenna 12, such as height of installation, and desired elevation angle (e.g., orientation about a horizontal axis, such as the X-axis of FIG. 4) of antenna 12, may also be displayed in the screen, if desired.

Although indicator 58 has been described as a component of feedback device 14. In other embodiments of the invention, indicator 58 can be implemented in another device, such as a Palm handheld device, that is separate from feedback device 14. In such case, feedback device 14 does not include indicator 58, but a transmitter connected to processor 55. The transmitter can be a cable or a wireless transmitter configured to send a signal to indicator 58.

FIG. 6 shows a block diagram of a feedback device 14b in accordance with other embodiments of the present invention. In addition to all the components of feedback device 14a, feedback device 14b also includes a digital signal processor 62 coupled to processor 55. Digital signal processor 62 receives radio frequency signal from antenna 12 via port 64, and modulates or de-modulates the radio frequency signal before transmitting the signal to processor 55. In this case, processor 55 is also configured to generate a signal when a processed radio frequency has a desirable quality (e.g., when a signal gain of antenna 12 has reached a certain threshold). Based on the signal generated by processor 55, indicator 58 then produces a response to alert an installer that a signal of desirable quality has been received by antenna 12. Digital signal processors, such as those manufactured by Texas Instruments Incorporated, Dallas, Tex., can be used for feedback device 14b. In the illustrated embodiments, indicator 58 includes three LEDs 66a-66c. First LED 66a is turned on when a measured orientation of antenna 12 is within a prescribed threshold from a desired orientation. Second LED 66b is turned on when a signal of desirable quality has been received by antenna 12, or when an installer has optimized orientation(s) of antenna 12 for best signal. Third LED 66c is turned on when a link is confirmed, a dial tone is present, and/or high-speed data is present.

Before antenna 12 is installed, data representative of a desired mounting configuration of antenna 12 is inputted into memory unit 56. A process 700 of initializing feedback device 14 will now be described with reference to FIGS. 7A and 7B. First, a location of structure 19 to which antenna 12 is to be mounted is determined (step 702). The position of structure 19 can be expressed in global positioning system (GPS) coordinates, or alternatively, in other coordinate systems. Next, a location of a base station 720 from which signal is to be received by antenna 12 is determined (step 704). Based on the locations of base station 720 and structure 19, a desired azimuth angle 722 of antenna 12 is determined (step 706). As shown in FIG. 7B, desired azimuth angle 722 is referenced from the magnetic north. If desired, adjustment for magnetic declination from true North can be made by processor 55 or by a user when memory unit 56 is initialized. Alternatively, desired azimuth angle 722 can be referenced from other global references, such as axis 724. Desired azimuth angle 722 is then stored in memory unit 56 (step 708). In some embodiments of the invention, a user interface, such as a computer or a hand-held device, is used to input desired azimuth angle 722 to feedback device 14. A cable can be used to connect the user interface to port 57 of feedback device 14, and be used to transmit data from the user interface to feedback device 14. Alternatively, desired azimuth angle 722 can be inputted to feedback device 14 via an infrared transmitter. In this case, port 57 of feedback device 14 includes an infrared receiver for receiving data from the infrared transmitter. In yet other embodiments, desired azimuth angle 722 can be stored in a SIM card. In this case, feedback device 14 does not include memory unit 56, and port 57 includes a SIM card receiver for receiving the SIM card. In other embodiments, desired azimuth angle 722 may be transmitted to feedback device 14 via a telephone line, a T-1 line, or a network cable.

Another process 800 of initializing feedback device 14 will now be described with reference to FIGS. 8A and 8B. First a horizontal distance 820 between structure 19 to which antenna 12 is to be mounted and a base station from which a signal is to be received by antenna 12 is determined (step 802). Next, a relative vertical distance 822 between structure 19 and the base station is determined (step 804). Based on horizontal distance 820 and vertical distance 822, a desired elevation angle 824 of antenna 12 is then determined (e.g., by using the formula: elevation angle=tan⁻¹(vertical distance/horizontal distance)) (step 806). As shown in FIG. 8B, desired elevation angle 824 is referenced from a horizontal axis. Alternatively, desired elevation angle 824 can be referenced from other axes. Desired elevation angle 824 is then stored in memory unit 56.

It should be noted that the initialization of feedback device 14 can include one or both of the processes 700 and 800, and that other types of data described previously can also be inputted into memory unit 56 during the initialization of feedback device 14. The initialization of feedback device 14 is performed at a point of sale in one embodiment. For example, when a user buys antenna 12 or when the user signs up for a service, an operator then input data to memory unit 56. Alternatively, the initialization of feedback device 14 can be performed during a manufacturing process of antenna 12. In this case, information associated with a desired mounting configuration of antenna 12 is transmitted to a manufacturing plant or a service facility, where feedback device 14 is initialized before it is shipped to a designated installer. In another alternative embodiment, the initialization of feedback device 14 can be performed during a manufacturing process of feedback device 14. In this case, information associated with a desired mounting configuration of antenna 12 is transmitted to a manufacturing plant or a service facility, where feedback device 14 is initialized before it is transported to another place where feedback device 14 will be installed on antenna 12. In some embodiments of the invention, the initialization of feedback device 14 can also be performed by an installer. For example, desired azimuth angle 722 and/or elevation angle 824 can be provided to the installer, who then would input the associated data into memory unit 56 before installing antenna 12.

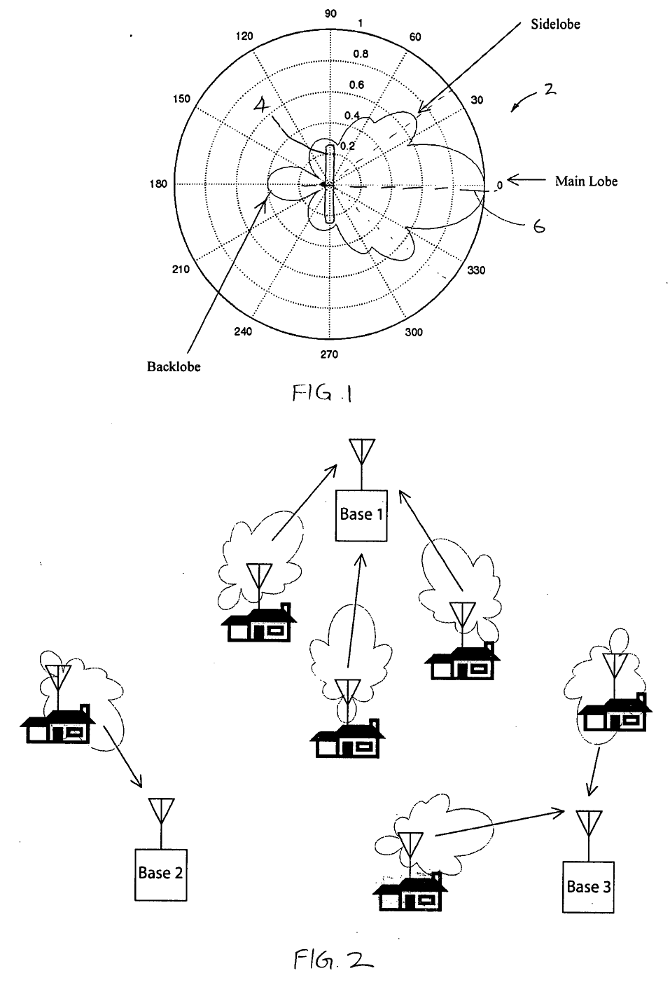

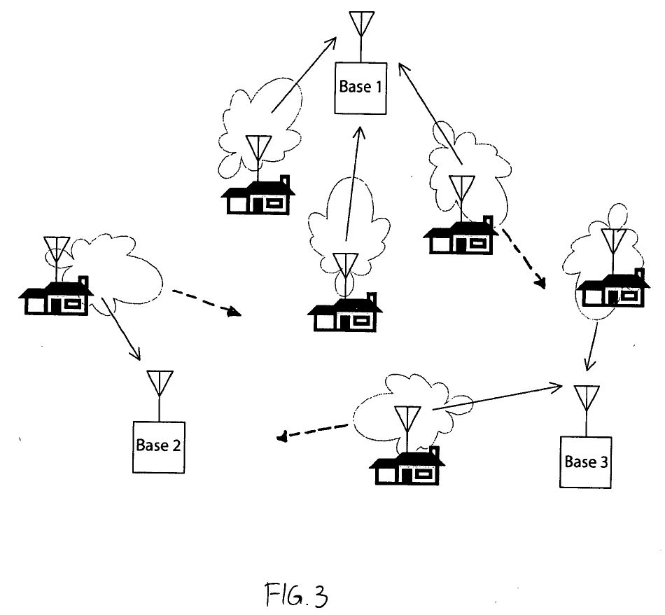

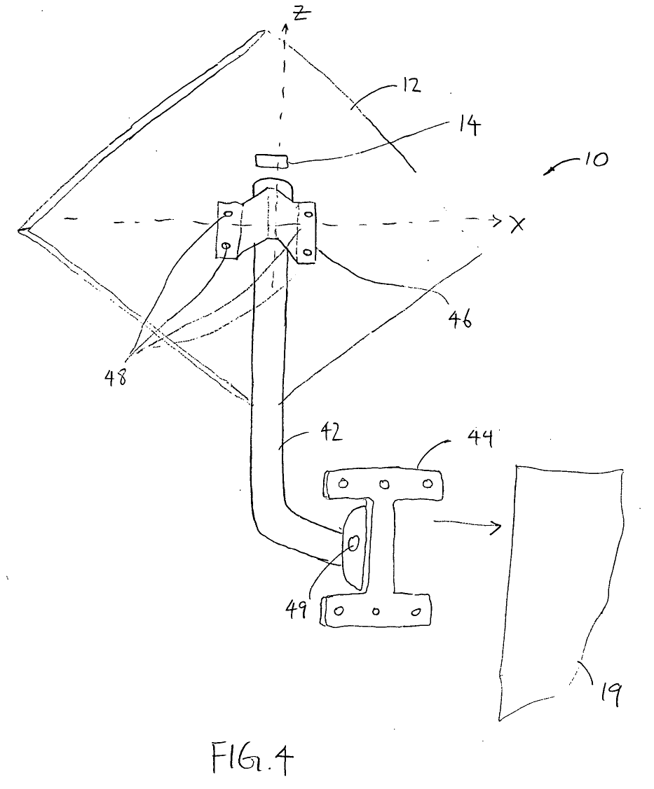

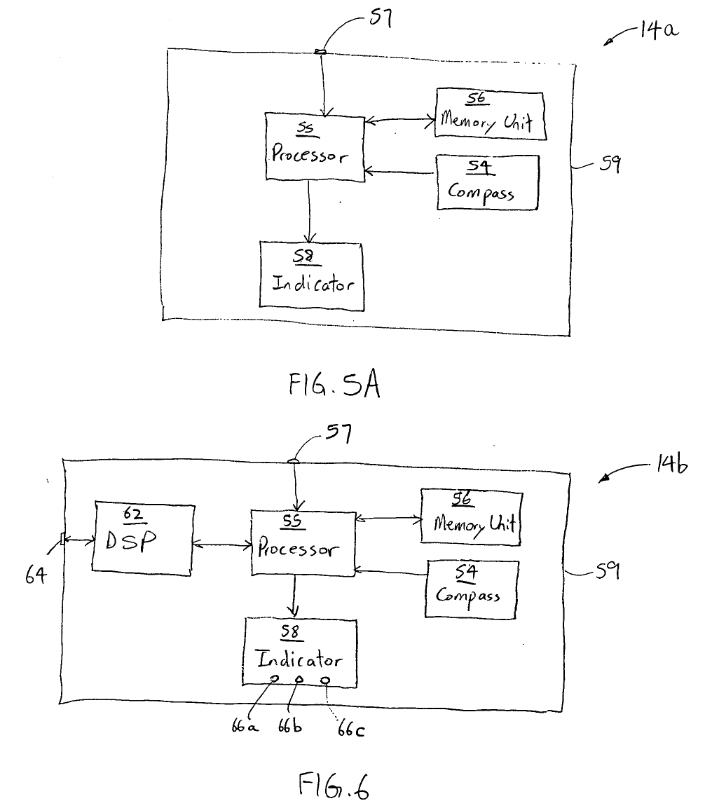

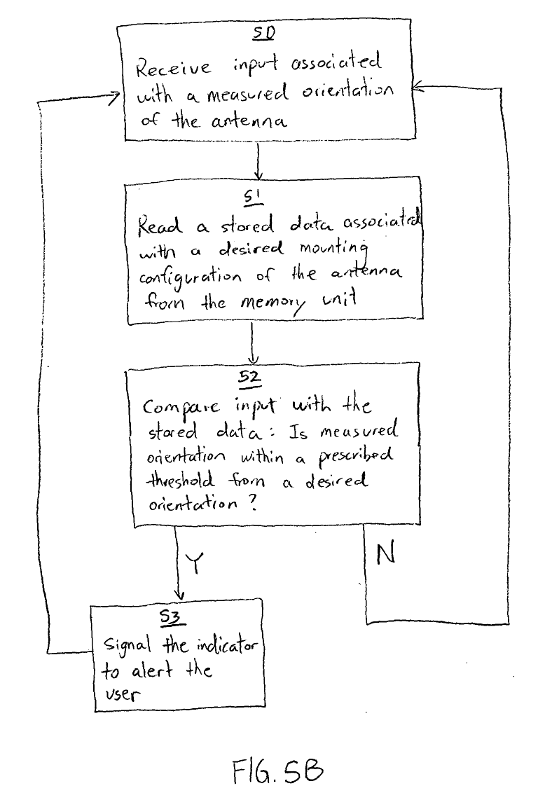

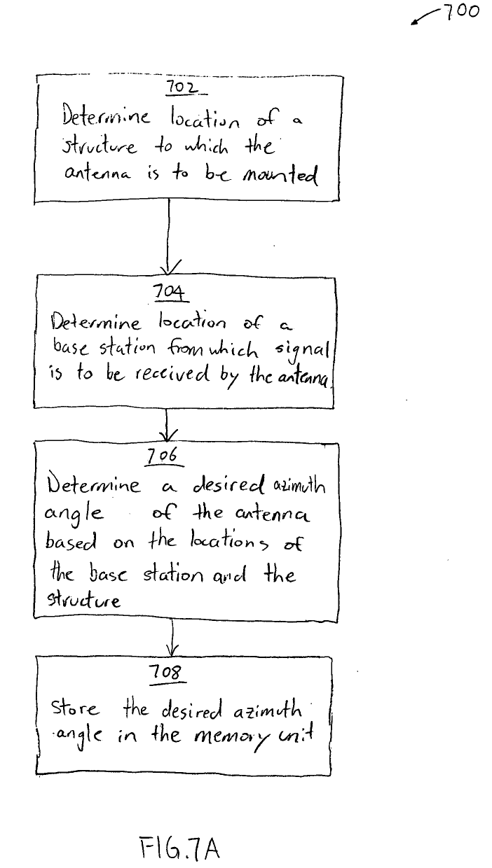

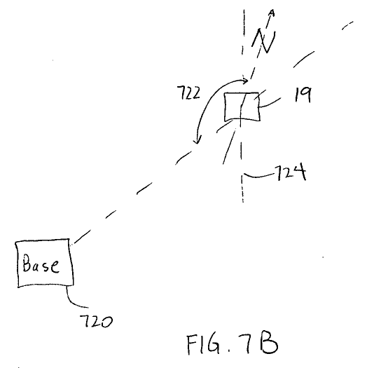

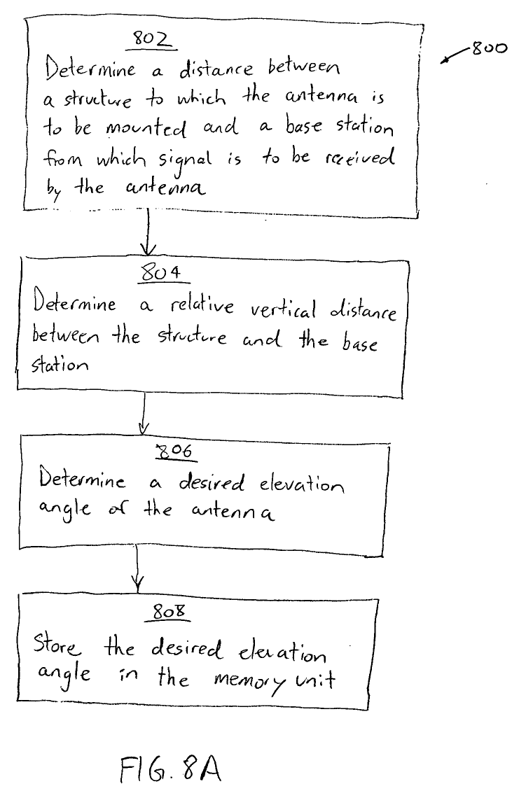

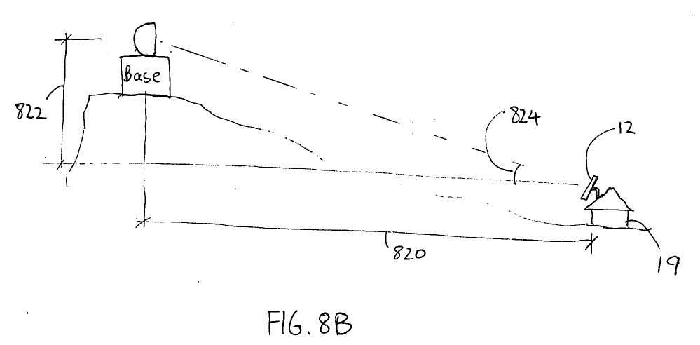

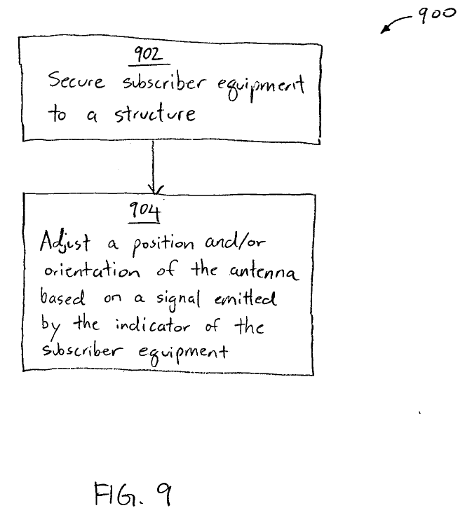

After data representative or a desired mounting configuration of antenna 12 has been inputted into memory unit 56, antenna 12 can then be installed on structure 19. FIG. 9 shows a method 900 of installing antenna 12, in accordance with some embodiments of the present invention. First, antenna 12 is secured to structure 19 (step 902). If antenna 12 includes mounting members 42, 44, and 46, these mounting member may be used to secure antenna 12 to structure 19. The securing can be accomplished by using one or more screws, or by a conventional method.

Next, the installer adjusts a position and/or orientation of antenna 12 based on a signal (or absence of a signal) emitted by indicator 58, until the orientation of antenna 12 is substantially the same or within a prescribed threshold from a desired mounting configuration of antenna 12 (step 904). For example, the installer can adjust the azimuth angle of antenna 12 until indicator 58 indicates to the installer that the azimuth angle of antenna 12 is substantially the same, or within a prescribed threshold from, a desired azimuth angle of antenna 12. As such, by allowing feedback device 14 itself to detect orientation of antenna 12, the installer can install antenna 12 more accurately, thereby reducing the chance that an interference be experienced due to human error in the installation process.

If feedback device 14 includes digital signal processor 62, the installer can further adjust a position and/or orientation of antenna 12 until indicator 58 indicates to the installer that a radio frequency signal of desirable quality has been received by antenna 12.

Although various embodiments have been described with reference to compass 54, processor 55, memory unit 56, and indicator 58, feedback device 14 may not include all of these components in alternative embodiments. For example, feedback device 14 may not include processor 55 and memory unit 56. In such case, compass 54 would measure an actual orientation of antenna 12 and indicator 58 then displays the measurement. Based on the measurement of the actual orientation of antenna 12 and a desired orientation that is provided to an installer, the installer then adjusts a position and/or orientation of antenna 12 until a desired mounting configuration of antenna 12 is achieved. In other embodiments, processor and memory unit that are already parts of a subscriber terminal may be used as processor 55 and memory unit 56. In such case, feedback device 14 can be configured to communicate with processor 55 and memory unit 56 associated with the subscriber terminal.

In addition, although compass 54, processor 55, memory unit 56, indicator 58, and digital signal processor 62 have been illustrated as separate components, in some embodiments, any of these components may be combined. For example, processor 55 and memory unit 56 can be manufactured as one unit in some embodiments.

Furthermore, although various embodiments have been described with reference to compass 54, the scope of the present invention should not be so limited. In alternative embodiments, system 10 or device 14 can include other types of sensing devices that can operate to facilitate an installation process of antenna 12. For example, feedback device 14 can include a tilt sensor to help an installer determine and confirm a desired mounting configuration of antenna 12. The tilt sensor can sense an orientation of antenna 12 about an axis, such as the X-axis of FIG. 4, thereby allowing an installer to determine an elevation angle of antenna 12. In such case, the installer can adjust the elevation angle of antenna 12 until indicator 58 indicates to the installer that the elevation angle of antenna 12 is substantially the same, or within a prescribed threshold from, a desired elevation angle of antenna 12. Examples of tilt sensors that can be used include those manufactured by PNI Corporation, Santa Rosa, Calif. In other embodiments of the invention, feedback device 14 can include a positional sensor, such as a GPS device, to help an installer determine and confirm a desired mounting location of antenna 12. Particularly, the GPS device can send a signal representative of a position of antenna 12 so that an installer can confirm whether an installation location is correct (i.e., when installation location matches with location data used to initialize memory unit 56).

Although particular embodiments of the present inventions have been shown and described, it will be understood that these descriptions are not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the following claims.

1. A system for receiving a communication signal, the system comprising:
an antenna that can be coupled to a subscriber terminal;
a compass secured to the antenna, the compass being adapted to measure an orientation of the antenna;
a memory unit for storing data associated with a desired mounting configuration of the antenna; and
a processor coupled to the compass and the memory unit, the processor configured to generate a signal based on a measured orientation of the antenna by the compass and data stored in the memory unit.

2. The system of claim 1, wherein the data is associated with a desired azimuth angle of the antenna.

3. The system of claim 2, wherein the processor is configured to generate the signal when a measured azimuth angle of the antenna is substantially the same as, or within a prescribed threshold from, the desired azimuth angle of the antenna.

4. The system of claim 2, wherein the processor is configured to generate the signal when a measured azimuth angle of the antenna is not substantially the same as, or beyond a prescribed threshold from, the desired azimuth angle of the antenna.

5. The system of claim 1, further comprising an indicator configured to receive the signal from the processor.

6. The system of claim 5, wherein the indicator comprises a light source for generating an optical signal in response to the signal generated by the processor.

7. The system of claim 5, wherein the indicator comprises an audio source for generating an audio signal in response to the signal generated by the processor.

8. The system of claim 5, wherein the indicator is configured to emit a signal when an orientation of the antenna is substantially the same as, or within a prescribed threshold from, a desired orientation of the antenna.

9. The system of claim 5, wherein the indicator is configured to emit a signal when an orientation of the antenna is not substantially the same as, or beyond a prescribed threshold from, a desired orientation of the antenna.

10. The system of claim 1, further comprising:
a tilt sensor secured to the antenna, the tilt sensor adapted to measure an elevation angle of the antenna;
wherein the processor is coupled to the tilt sensor, and the processor is further configured to generate a signal based on a measured elevation angle of the antenna and data stored in the memory unit.

11. The system of claim 10, wherein the stored data comprises data associated with a desired elevation angle of the antenna.

12. The system of claim 1, further comprising:
a positional sensor secured to the antenna, the positional sensor adapted to measure a position of the antenna;
wherein the processor is coupled to the positional sensor, and the processor is further configured to generate a signal based on a measured position of the antenna and data stored in the memory unit.

13. The system of claim 12, wherein the data stored in the memory unit comprises data associated with a desired position of the antenna.

14. The system of claim 1, further comprising:
a digital signal processor for processing radio frequency signal received by the antenna;
wherein the processor is coupled to the digital signal processor and is configured to generate a signal based on a processed radio frequency signal.

15. The system of claim 14, wherein the processor is configured to generate the signal when the processed radio frequency signal has a desirable quality.

16. A device for installing an antenna, comprising:
a structure attachable to the antenna;
a compass secured to the structure, the compass being adapted to measure an orientation of the antenna;
a memory unit for storing data associated with a desired mounting configuration of the antenna; and
a processor coupled to the compass and the memory unit, the processor configured to generate a signal based on a measured orientation of the antenna by the compass and data stored in the memory unit.

17. The device of claim 16, wherein the data is associated with a desired azimuth angle of the antenna.

18. The device of claim 17, wherein the processor is configured to generate the signal when a measured azimuth angle of the antenna is substantially the same as, or within a prescribed threshold from, the desired azimuth angle of the antenna.

19. The device of claim 17, wherein the processor is configured to generate the signal when a measured azimuth angle of the antenna is not substantially the same as, or beyond a prescribed threshold from, the desired azimuth angle of the antenna.

20. The device of claim 16, further comprising an indicator configured to receive the signal from processor.

21. The device of claim 20, wherein the indicator comprises a light source for generating an optical signal in response to the signal generated by the processor.

22. The device of claim 20, wherein the indicator comprises an audio source for generating an audio signal in response to the signal generated by the processor.

23. The device of claim 20, wherein the indicator is configured to emit a signal when an orientation of the antenna is substantially the same as, or within a prescribed threshold from, a desired orientation of the antenna.

24. The device of claim 20, wherein the indicator is configured to emit a signal when an orientation of the antenna is not substantially the same as, or beyond a prescribed threshold from, a desired orientation of the antenna.

25. The device of claim 16, further comprising:
a tilt sensor secured to the antenna, the tilt sensor adapted to measure an elevation angle of the antenna;
wherein the processor is coupled to the tilt sensor, and the processor is further configured to generate a signal based on a measured elevation angle of the antenna and data stored in the memory unit.

26. The device of claim 25, wherein the memory unit comprises data associated with a desired elevation angle of the antenna.

27. The device of claim 17, further comprising:
a positional sensor secured to the antenna, the positional sensor adapted to measure a position of the antenna;
wherein the processor is coupled to the positional sensor, and the processor is further configured to generate a signal based on a measured position of the antenna and a stored data in the memory unit.

28. The device of claim 27, wherein the memory unit comprises data associated with a desired position of the antenna.

29. The device of claim 16, further comprising:
a digital signal processor for processing radio frequency signal received by the antenna;
wherein the processor is coupled to the digital signal processor and is configured to generate a signal based on a processed radio frequency signal.

30. The device of claim 29, wherein the processor is configured to generate the signal when the processed radio frequency signal has a desirable quality.

31. A device for processing data associated with an installation of an antenna, the device comprising a processor, wherein the processor is configured to:
receive an input associated with a measured orientation of an antenna;
compare the input with data associated with a desired mounting configuration of the antenna; and
generate a signal based on the comparing.

32. The device of claim 31, wherein the processor is further configured to read the data from a memory unit.

33. The device of claim 31, wherein the processor is configured to receive the input from a circuit based compass.

34. The device of claim 33, wherein the measured orientation of the antenna comprises an azimuth angle of the antenna, and the desired mounting configuration of the antenna comprises a desired azimuth angle of the antenna.

35. The device of claim 34, wherein the processor is configured to generate the signal when a measured azimuth angle of the antenna is substantially the same as, or within a prescribed threshold from, the desired azimuth angle of the antenna.

36. The device of claim 34, wherein the processor is configured to generate the signal when a measured azimuth angle of the antenna is not substantially the same as, or beyond a prescribed threshold from, the desired azimuth angle of the antenna.

37. The device of claim 31, wherein the processor is configured to receive an input from a tilt sensor.

38. The device of claim 37, wherein the measured orientation of the antenna comprises an elevation angle of the antenna, and the desired mounting configuration of the antenna comprises a desired elevation angle of the antenna.

39. The device of claim 38, wherein the processor is configured to generate the signal when a measured elevation angle of the antenna is substantially the same as, or within a prescribed threshold from, the desired elevation angle of the antenna.

40. The device of claim 38, wherein the processor is configured to generate the signal when a measured elevation angle of the antenna is not substantially the same as, or beyond a prescribed threshold from, the desired elevation angle of the antenna.

41. The device of claim 31, wherein the processor is configured to receive an input from a digital signal processor, and generate the signal when an input from the digital signal processor indicates that a radio frequency signal received by the antenna has a desirable quality.

42. A system for receiving a communication signal, comprising:
an antenna that can be coupled to a subscriber terminal; and
a compass fixedly secured to the antenna, the compass being adapted to measure an orientation of the antenna.

43. The system of claim 42, wherein the compass is a circuit-based compass.

44. A method of installing an antenna, comprising:
securing the antenna to a structure, the antenna carrying a feedback device that provides a signal based on an orientation of the antenna and a desired mounting configuration of the antenna;
adjusting a position or orientation of the antenna based on the signal or an absence of the signal.

45. The method of claim 44, wherein the orientation of the antenna comprises an azimuth angle of the antenna, and the desired mounting configuration comprises a desired azimuth angle of the antenna.

46. The method of claim 44, wherein the orientation of the antenna comprises an elevation angle of the antenna, and the desired mounting configuration comprises a desired elevation angle of the antenna.

47. The method of claim 44, wherein the signal comprises an optical signal and the adjusting comprises positioning or orienting the antenna based on the optical signal.

48. The method of claim 44, wherein the signal comprises a termination of an optical signal, and the adjusting comprises positioning or orienting the antenna until the optical signal is terminated.

49. The method of claim 44, wherein the signal comprises an audio signal and the adjusting comprises positioning or orienting the antenna based on the audio signal.

50. The method of claim 44, wherein the signal comprises a termination of an audio signal, and the adjusting comprises positioning or orienting the antenna until the audio signal is terminated.

51. The method of claim 44, wherein the signal comprises a text message and the adjusting comprises positioning or orienting the antenna based on the text message.

52. The method of claim 44, wherein the adjusting comprises changing an elevation angle of the antenna.

53. The method of claim 44, wherein the adjusting comprises changing an azimuth angle of the antenna.

54. The method of claim 44, wherein the antenna further carrying a memory unit, and the method further comprising inputting data associated with the desired mounting configuration of the antenna to the memory unit.

55. A method of initializing a feedback device secured to an antenna, the feedback device having a memory unit, the method comprising:
inputting data associated with a desired mounting configuration of the antenna to the memory unit.

56. The method of claim 55, wherein the data comprises a desired orientation of the antenna.

57. The method of claim 56, wherein the desired orientation comprises a desired azimuth angle of the antenna.

58. The method of claim 56, wherein the desired orientation comprises an elevation angle of the antenna.

59. The method of claim 56, further comprising determining the desired orientation of the antenna.

60. The method of claim 59, wherein the determining the desired orientation of the antenna comprises:
determining a position of a base station from which signal is to be received by the antenna;
determining a position of the structure to which the antenna is to be secured; and
determining a desired azimuth angle of the antenna based on the positions of the base station and the structure.

61. The method of claim 59, wherein the determining the desired orientation of the antenna comprises:
determining a distance between a base station from which signal is to be received by the antenna and a position of the structure to which the antenna is to be secured;
determining a relative vertical distance between the antenna and the base station;
determining a desired elevation angle of the antenna based on the distance and the relative vertical distance.

62. The method of claim 55, wherein the data comprises information associated with a base station from which signal can be received by the antenna.
